(19) United States
(12) Patent Application Publication
(10) Pub. No.: US 2020/0380445 A1
(43) Pub. Date: Dec. 3, 2020

(54) OPTIMIZING REVENUE USING OPERATIONAL EXPENDITURE COSTS

(71) Applicant: INTERNATIONAL BUSINESS MACHINES CORPORATION, Armonk, NY (US)

(72) Inventors: DATTARAM BIJAVARA ASWATHANARAYANA RAO, BANGALORE (IN); Jegan Jegadeesan, Chennai (IN); Siddique M. Adoni, Bangalore (IN)

(21) Appl. No.: 16/429,173

(22) Filed: Jun. 3, 2019

(51) Int. Cl. G06Q 10/06; G06Q 30/02

(52) U.S. Cl. CPC G06Q 10/06375; G06Q 30/0202

(57) ABSTRACT

A method, a computer program product, and a computer system determine a schedule of a sale event for a retailer. The method includes determining a respective gross revenue gain from launching the sale event at a plurality of times. For each time, the method includes determining respective offsetting factors that introduce a respective cost that reduces the respective gross revenue gain and determining a respective net revenue gain based on the respective gross revenue gain and the respective cost associated with the respective offsetting factors. The method includes generating a recommendation of a select one of the times having a highest one of the net revenue gains.

### BACKGROUND

The exemplary embodiments relate generally to revenue from a sale event, and more particularly to optimizing the revenue gains based on offsetting operational expenditure costs during the sale event.

A retailer may launch a sale event at various times for a variety of reasons. For example, the sale event may be launched for a relatively short duration lasting several hours, a relatively long duration lasting several days or weeks, etc. The sale event may be launched to increase profit, clear inventory, etc. The sale event may be characterized by discounts on select retail items that are intended to attract a large number of customers who purchase the retail items at a greater amount than without the sale event. Although the sale event may lead to increased revenue gains despite the decreased margins per item, these revenue gains may be offset due to a poor scheduling of the sale event that have increased operational costs. For example, the increased number of customers within a retail space at a given time may cause an increase in usage of temperature control devices (e.g., air conditioning). This increase and the corresponding utility costs may offset any revenue gains that were realized from increased sales during the sale event.

### SUMMARY

The exemplary embodiments disclose a method, a computer program product, and a computer system for determining a schedule of a sale event for a retailer. The method comprises determining a respective gross revenue gain from launching the sale event at a plurality of times. For each time, the method comprises determining respective offsetting factors that introduce a respective cost that reduces the respective gross revenue gain and determining a respective net revenue gain based on the respective gross revenue gain and the respective cost associated with the respective offsetting factors. The method comprises generating a recommendation of a select one of the times having a highest one of the net revenue gains.

### BRIEF DESCRIPTION OF THE SEVERAL VIEWS OF THE DRAWINGS

The following detailed description, given by way of example and not intended to limit the exemplary embodiments solely thereto, will best be appreciated in conjunction with the accompanying drawings, in which:

FIG. 1 depicts an exemplary schematic diagram of a sale scheduling recommendation system 100, in accordance with the exemplary embodiments.

FIG. 2 depicts an exemplary flowchart illustrating the operations of a recommendation program 132 of the sale scheduling recommendation system 100 in determining a schedule of a sale event for a retailer, in accordance with the exemplary embodiments.

FIG. 3 depicts an exemplary block diagram depicting the hardware components of the sale scheduling recommendation system 100 of FIG. 1, in accordance with the exemplary embodiments.

FIG. 4 depicts a cloud computing environment, in accordance with the exemplary embodiments.

FIG. 5 depicts abstraction model layers, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

The exemplary embodiments are directed to a method, computer program product, and system for determining a schedule of a sale event for a retailer. As will be described in greater detail below, the exemplary embodiments are configured to determine when a sale event is to be launched at a retailer and the duration of the sale event. The exemplary embodiments may receive parameters that define criteria to be followed for the sale event and identify details of a requesting retailer to determine contributing factors that may offset revenue gains from the sale event. Key benefits of the exemplary embodiments may include optimizing an estimated revenue gain from launching a sale event at a retailer by factoring in any offset to the revenue gain, particularly by operational expenditure costs. Detailed implementation of the exemplary embodiments follows.

Conventional approaches to optimizing revenue gains from selling retail items focus on the rate at which retail items are sold and a margin that the sale of the retail item returns to the retailer. The conventional approaches may incorporate historical performances having known conditions to estimate an amount of future sales of similar retail items. Thus, the conventional approaches may be configured to predict an estimate of revenue gains based on these historical performances under similar conditions. For example, the conventional approaches may utilize historical performances having known weather conditions to estimate future sales based on weather forecasts having similar weather conditions. In this manner, the conventional approaches may adapt a sale event according to weather forecasts. In another example, the conventional approaches may focus on the price for the sale of retail items to optimize revenue gains. Thus, historical performances based on discount rates may be used in the conventional approaches to predict how to set future discount rates to optimize revenue gains. However, these conventional approaches ultimately rely purely on an amount of retail items being moved and the resulting revenue gains from their sales (e.g., the gross revenue gains from selling the retail items).

The exemplary embodiments are configured to incorporate offsetting factors that affect revenue gains from sales of retail items, particularly during a sale event. Consequences of holding a sale event from operational costs and energy consumption may contribute a substantial cost to the retailer such that an overall net revenue gain may be offset or reduced. When considering a retail chain including the retailer where the sale event is held nationwide, across continents, etc., at multiple retail locations, the cumulative cost associated with the operational costs and energy consumption may become significant to the retail chain where the overall offset from these factors may diminish the revenue gains of the retail chain. To comprehensively determine the revenue gains from a future sale event, the exemplary embodiments may determine how to compensate for offsetting factors such as energy consumption and other operational expenditure costs while minimizing an effect to revenue gains and customer flow. In this manner, the exemplary embodiments may determine how high energy consumption and operational costs offset the revenue gains from sale events to be launched. The exemplary embodiments may intelligently recommend a schedule for a sale event to be launched (e.g., a day, a time, a duration, etc.) to optimize the net revenue gains.

The exemplary embodiments are described with regard to determining a schedule for a sale event launched by a retailer or retail chain. However, the exemplary embodiments being directed to a sale event is only illustrative. The exemplary embodiments may be utilized in other retail scenarios that do not involve a sale event. The exemplary embodiment being directed to a retail space is also only illustrative. The exemplary embodiments may be implemented or modified to be used in non-retail scenarios that optimize a particular goal. For example, the exemplary embodiments may be implemented to determine a contributing, offsetting factor that affects the goal in a given scenario. Through incorporation of the offsetting factors, a more comprehensive estimate may be reached in estimating or optimizing the goal from launching the scenario.

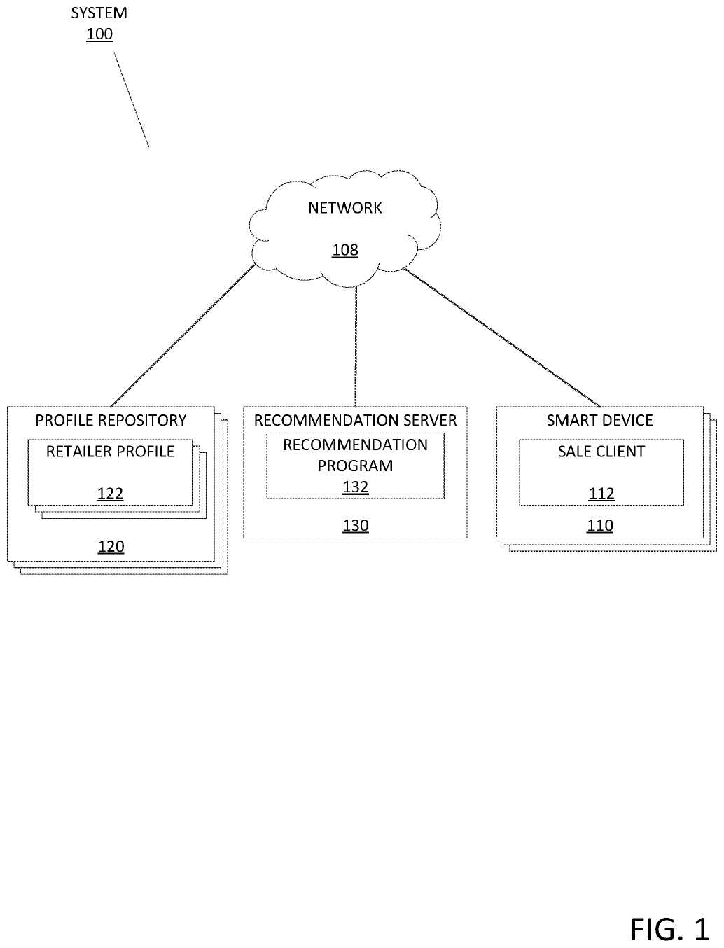

FIG. 1 depicts a sale scheduling recommendation system 100, in accordance with the exemplary embodiments. According to the exemplary embodiments, the sale scheduling recommendation system 100 may include one or more smart devices 110, one or more profile repositories 120, and a recommendation server 130, which may all be interconnected via a network 108. While programming and data of the exemplary embodiments may be stored and accessed remotely across several servers via the network 108, programming and data of the exemplary embodiments may alternatively or additionally be stored locally on as few as one physical computing device or amongst other computing devices than those depicted.

In the exemplary embodiments, the network 108 may be a communication channel capable of transferring data between connected devices. Accordingly, the components of the sale scheduling recommendation system 100 may represent network components or network devices interconnected via the network 108. In the exemplary embodiments, the network 108 may be the Internet, representing a worldwide collection of networks and gateways to support communications between devices connected to the Internet. Moreover, the network 108 may utilize various types of connections such as wired, wireless, fiber optic, etc. which may be implemented as an intranet network, a local area network (LAN), a wide area network (WAN), or a combination thereof. In further embodiments, the network 108 may be a Bluetooth network, a WiFi network, or a combination thereof. In yet further embodiments, the network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices. For example, the network 108 may also represent direct or indirect wired or wireless connections between the components of the sale scheduling recommendation system 100 that do not utilize the network 108.

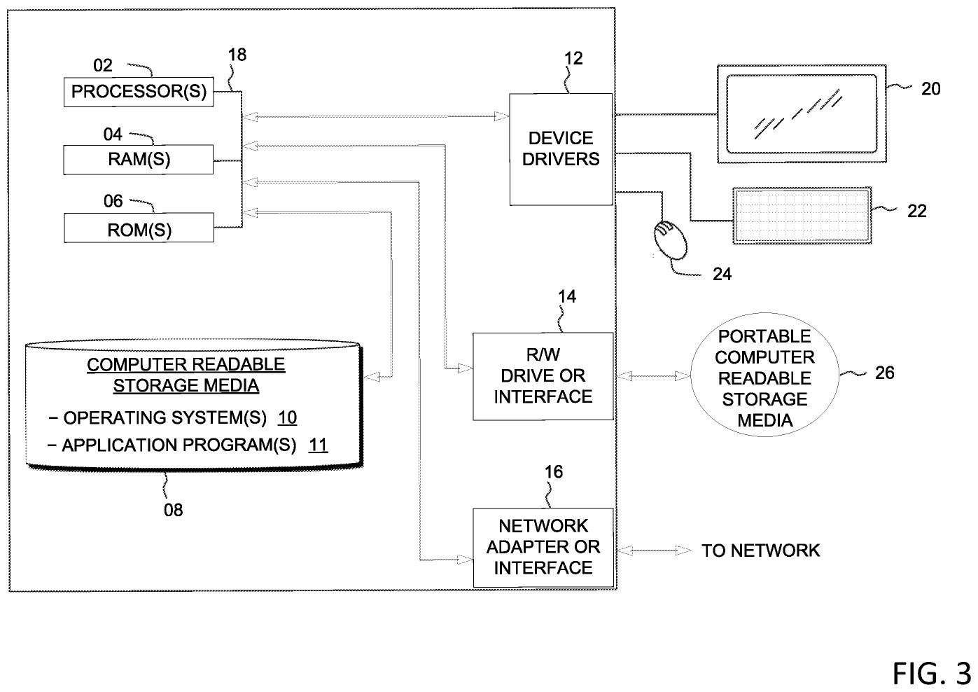

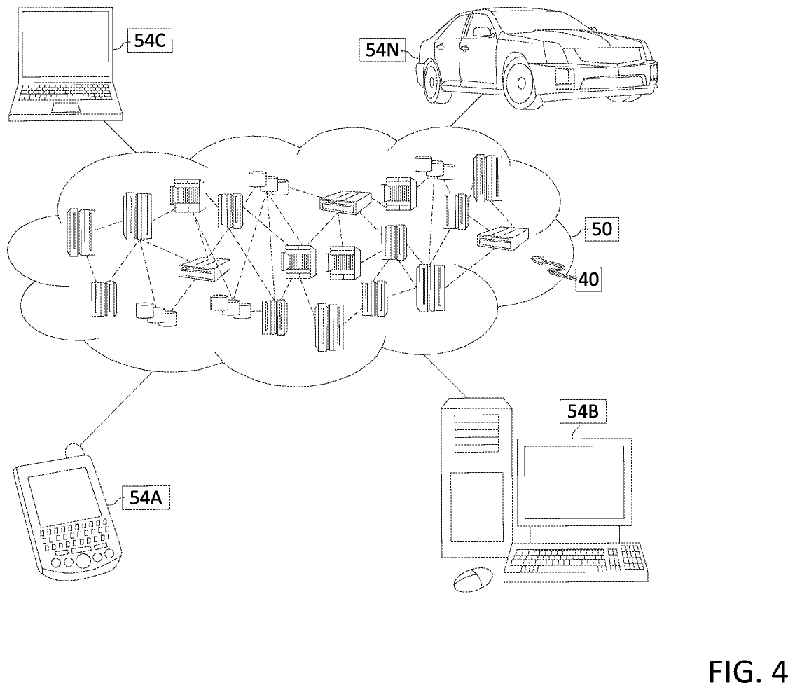

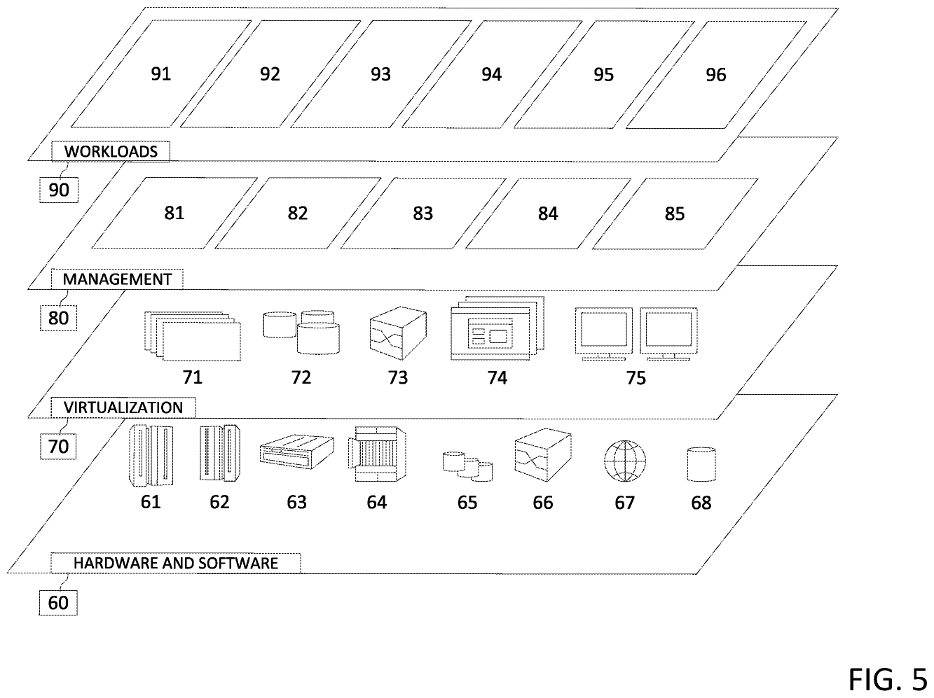

In the exemplary embodiments, the smart device 110 may include a sale client 112 and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an Internet of Things (IoT) device, or any other electronic device or computing system capable of receiving and sending data to and from other computing devices. While the smart device 110 is shown as a single device, in other embodiments, the smart device 110 may be comprised of a cluster or plurality of computing devices, in a modular manner, etc., working together or working independently. The smart device 110 is described in greater detail as a hardware implementation with reference to FIG. 3, as part of a cloud implementation with reference to FIG. 4, and/or as utilizing functional abstraction layers for processing with reference to FIG. 5.

In the exemplary embodiments, the sale client 112 may act as a client in a client-server relationship and may be a software, hardware, and/or firmware based application capable of joining a meeting via the network 108. In the exemplary embodiments, the sale client 112 may operate as a user interface allowing a user to interact with one or more components of the sale scheduling recommendation system 100, and utilize various wired and/or wireless connection protocols for data transmission and exchange associated with recommending a schedule for a sale event to be launched at a retailer, including Bluetooth, 2.4 gHz and 5 gHz internet, near-field communication, Z-Wave, Zigbee, etc.

The sale client 112 may be configured to provide, to the user, a user interface in which to request one or more recommendations of when to schedule a sale event along with respective details of each recommendation. For example, the sale client 112 may show a user interface to the user (e.g., a retail store owner, a retail store manager, a retail chain administrator, etc.) so that the user may enter an identity of the retailer or retail chain along with parameters defining select criteria for the sale event to be scheduled. The parameters may include a general timeframe of when the sale event is to be launched, retail items to be discounted during the sale event, an inventory of retail items at the retailer, etc. The parameters may provide boundaries in which to determine the recommendations of when to schedule the sale event. The user interface may allow the user to indicate if a parameter is a requirement (e.g., a strict boundary) or a preference (e.g., a loose boundary). Thus, in determining the recommendations, the parameters may be incorporated into any determination where a requirement is included and a preference may be included. The user may also submit a general request to receive a recommendation of when to schedule a sale event without parameters. According to another exemplary embodiment, the sale client 112 may receive recommendations without having submitted a request. Based on operations described below in determining recommendations, the exemplary embodiments may identify situations in which a sale event may be scheduled by a retailer. When the identified situation is determined, the exemplary embodiments may be configured to automatically generate and transmit the recommendations to the retailer via the sale client 112. In receiving the recommendations without a request, the retailer being associated with the sale scheduling recommendation system 100 may enable this manner of providing recommendations. The retailer may also subscribe to the sale scheduling recommendation system 100 to receive recommendations without a request at various times (e.g., as defined in a time period of the subscription, whenever an identified scenario is determined, etc.).

In the exemplary embodiments, the profile repository 120 may include one or more retailer profiles 122 and may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of storing, receiving, and sending data to and from other computing devices. While the profile repository 120 is shown as a single device, in other embodiments, the profile repository 120 may be comprised of a cluster or plurality of electronic devices, in a modular manner, etc., working together or working independently. While the profile repository 120 is also shown as a separate component, in other embodiments, the profile repository 120 may be incorporated with one or more of the other components of the sale scheduling recommendation system 100. For example, the profile repository 120 may be incorporated in the recommendation server 130. Thus, access to the profile repository 120 by the recommendation server 130 may be performed locally. In another example, the profile repository 120 may be incorporated in the smart device 110 (e.g., each smart device 110 has a profile repository 120 including at least the retailer profile 122 associated with the user). Thus, access to the profile repository 120 and to a specific one of the retailer profiles 122 may be performed through a transmission from the smart device 110. The profile repository 120 is described in greater detail as a hardware implementation with reference to FIG. 3, as part of a cloud implementation with reference to FIG. 4, and/or as utilizing functional abstraction layers for processing with reference to FIG. 5.

In the exemplary embodiments, the retailer profiles 122 may be associated with respective retailers or retail chains. The retailer profiles 122 may be populated with information that is manually provided by respective users. For example, the user may enter various types of information into the retailer profile 122 such as management, an employment force, available employees at different operating hours, retail items sold at the retail location, etc. The retailer profiles 122 may also be populated with information that is automatically determined based on various types of available information such as address of retailer, size of the retail space of the retailer, available parking at the retail space, operating hours, etc. The retailer profiles 122 may further include historical information of the retailer. The historical information may be directed toward past sale events launched at the retailer, conditions during the past sale events (e.g., weather conditions), results of launching the past sale events, discount rates used for retail items during the past sale events, placement in the retail space of retail items that were discounted during the sale events, etc.

The retailer profiles 122 may additionally include information relating to operational expenditures of retailers. For example, the operational expenditure information may indicate a current or expected utility rate at which a utility (e.g., electricity, water, gas, etc.) is received at a particular retailer. The historical information may also include information related to the operational expenditures of the retailer. For example, the historical information may indicate customer traffic on a given day and/or the conditions at which a given customer traffic was experienced. For the customer traffic, the operational expenditure information may indicate the operational expenditures when the given customer traffic was experienced. For example, for a sale event that was launched, the historical information may indicate a number of customers who were present in the retail space during a selected timeframe while the operational expenditure information may indicate a resulting utility cost in view of the number of customers. In another example, the historical information may indicate a number of retail items on a showroom floor of the retailer during a sale event. The operational expenditure information may indicate the operational expenditures from the number of retail items utilizing one or more utilities (e.g., energy consumption due to a spotlight that illuminates the retail item, a refrigeration unit that preserves the retail item, etc.).

In the exemplary embodiments, the recommendation server 130 may include a recommendation program 132 and act as a server in a client-server relationship with the sale client 112 as well as be in a communicative relationship with the profile repository 120. The recommendation server 130 may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of receiving and sending data to and from other computing devices. While the recommendation server 130 is shown as a single device, in other embodiments, the recommendation server 130 may be comprised of a cluster or plurality of computing devices, working together or working independently. The recommendation server 130 is described in greater detail as a hardware implementation with reference to FIG. 3, as part of a cloud implementation with reference to FIG. 4, and/or as utilizing functional abstraction layers for processing with reference to FIG. 5.

In the exemplary embodiments, the recommendation program 132 may be a software, hardware, and/or firmware application configured to receive a request from a retailer for a recommendation of when to schedule a sale event and generate one or more recommendations for the retailer. The recommendation program 132 may determine whether the request that is received includes parameters that form at least a partial basis upon which to generate the recommendations. The recommendation program 132 may access the retailer profile 122 corresponding to the retailer transmitting the request or receive the retailer profile 122 from the sale client 112. The recommendation program 132 may utilize the information contained therein along with the parameters to generate the recommendations. As will be described in further detail below, the recommendations may be based on how operational expenditures offset gross estimated revenue gains from launching a sale event at a recommended time and for a recommended duration while considering any parameter indicated by the retailer.

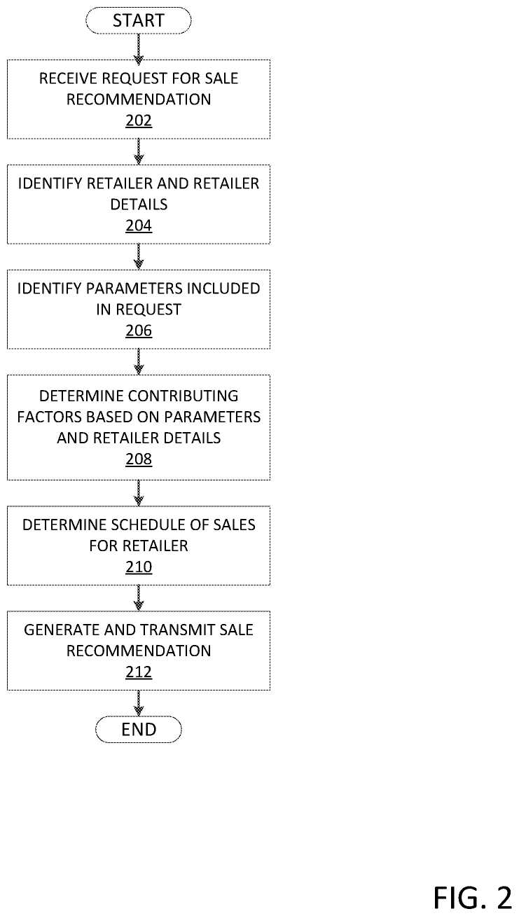

FIG. 2 illustrates the operations of the recommendation program 132 of the sale scheduling recommendation system 100 in determining a schedule of a sale event for a retailer, in accordance with the exemplary embodiments.

The recommendation program 132 may receive a request for a recommendation of when to launch a sale event from a retailer or a retail chain (step 202). For illustrative purposes, the exemplary embodiments are described with regard to a single retailer submitting the request. However, those skilled in the art will understand that the exemplary embodiments may also be utilized for a retail chain including a plurality of retailers with corresponding retail locations and respective characteristics (e.g., as indicated in the retailer profiles 122) to generate the recommendation. When used with a retail chain, the results determined across the retailers of the retail chain may be analyzed to determine how to optimize the revenue gains. A user associated with the retailer may utilize a user interface provided by the sale client 112 on the smart device 110 to transmit the request to the recommendation program 132 on the recommendation server 130 via the network 108.

To further illustrate the operations of the recommendation program 132, reference is now made to an illustrative example. According to the illustrative exemplary embodiment, a user may be a manager of a retailer at a retail location. The retailer may sell retail items that are refrigerated such as a supermarket selling frozen foods. The user may utilize the smart device 110 (e.g., a manager's computer) to execute the sale client 112 and open a user interface on which to submit the request for the recommendation. The sale client 112 may receive inputs from the user (e.g., parameters for the recommendation) and package a request along with other information. For example, the other information may include an identity of the retailer (e.g., supermarket with an identification number unique to the retailer), an identity of the user (e.g., a user identification unique to the manager), etc. When the user has indicated that the request is to be submitted, the sale client 112 may generate the request for transmission including the above noted information such that the recommendation program 132 receives the request.

The recommendation program 132 may identify the retailer and details of the retailer (step 204). Based on the identity of the retailer, the recommendation program 132 may retrieve the retailer profile 122 corresponding to the retailer requesting the recommendation from the profile repository 120. The retailer profile 122 may include the details of the retailer indicating characteristics such as workforce information, operating attributes, inventory types, inventory stock, utility use, utility rates, historical performance information, etc.

With reference again to the previously introduced example, the recommendation program 132 may determine an identity of the retailer as a supermarket at a specific retail location. The recommendation program 132 may determine that the supermarket has a number of employees performing various tasks during the operating hours of a day, within a select duration in a day, etc. The recommendation program 132 may determine that the supermarket includes refrigeration units to house retail items to maintain a temperature corresponding to the retail item. The recommendation program 132 may determine a number of the refrigeration units that are in a display location within the retail space where customers may select retail items for purchase and a number of the retail items that are within the refrigeration units. The recommendation program 132 may determine how much utilities (e.g., an amount of electricity) are used (e.g., historically) in operating the retailer, particularly for the refrigeration units during operating hours for customers. The recommendation program 132 may determine a rate at which utilities are paid (e.g., historically, currently, etc.). Based on trends at which a utility rate is set, the recommendation program 132 may also be configured to predict a utility rate at a future time. However, if the predicted utility rate is unavailable, the recommendation program 132 may rely on a current utility rate to be applied to the future time. The recommendation program 132 may determine when previous sale events were launched, the conditions (e.g., weather) experienced during the previous sale events, the discount rates and retail items that were discounted during the previous sale events, the results (e.g., revenue gains) from having launched the previous sale events, etc. Those skilled in the art will appreciate that the recommendation program 132 may determine further information from the retailer profile 122 of the retailer or from other available sources that may contribute to generating the recommendations. For example, the other available sources may include a manual entry such as by transmitting a request back to the user associated with the retailer to provide the further information that may be used in generating the recommendations.

The recommendation program 132 may identify parameters included in the request from the retailer (step 206). Through the user interface provided by the sale client 112, the user associated with the retailer may enter parameters that may be considered by the recommendation program 132 when generating the recommendations. The parameters may represent requirements and/or preferences to be incorporated in a sale event to be launched. For example, a retailer may have excess stock of a retail item. Thus, when submitting the request, the user associated with the retailer may indicate that this retail item is to be discounted or emphasized in the sale event to offload the retail stock at the retailer's retail location. In another example, a retailer may have reasons to limit a sale event to a particular day or date, select hours of the operating hours, etc. Thus, when submitting the request, the user associated with the retailer may indicate that the sale event is to conform to the defined timing parameters set forth in the request.

Referring now to the previously introduced, illustrative example, the user associated with the supermarket may have entered one or more parameters as part of the request submitted to the recommendation program 132. For example, the supermarket may have an excess of a refrigerated retail item in stock. Thus, the user may include in the request that this refrigerated retail item is to be offloaded such as by being discounted to entice customers to purchase this refrigerated retail item or being placed in a position of the retail space with higher customer circulation. In another example, there may be an event occurring at a complex in which the supermarket is located which expects an increased amount of foot traffic. To take advantage of the additional foot traffic, the user associated with the supermarket may have indicated a timeframe corresponding to the event as a timing parameter (e.g., date and time) included in the request. For example, the timing parameter may indicate that the sale event is to occur on Jan. 20, 2019 throughout any duration of the operating hours. For each parameter included in the request, the recommendation program 132 may identify the parameters and their effect on recommendations that are generated.

The recommendation program 132 may determine contributing factors that offset revenue gains based on the parameters and the retailer details (step 208). The offsetting factors may be any aspect that reduces the revenue gains with regard to a net financial position. For example, in a given timeframe, the net financial position may be a total estimated revenue gain from the sale of retail items reduced by operational expenditure costs accrued in the timeframe. The recommendation program 132 may determine the offsetting factors based on a financial perspective. However, the recommendation program 132 may be configured to further incorporate non-financial perspectives (e.g., efficiency of the work force) in determining offsetting factors.

Although a sale event may lead to increased sales and increased revenue gains, the scheduling of the sale event may introduce operational expenditure costs in the form of offsetting factors that reduce the net revenue gains when considering the financial position of the retailer. The operational expenditure costs (e.g., energy consumption) may be a major cost for the retailer where a cumulative amount of the operational expenditure costs becomes significantly high. The operational expenditure costs may be largely dependent on a plurality of factors. For example, the operational expenditure costs may be based on a number of customers at the retail location of the retailer. With an increased number of customers on the premises of the retailer, energy consuming devices (e.g., an air conditioning unit) may run at a higher configuration (e.g., to maintain a temperature set for the interior of the space of the retailer). The higher configuration may lead to higher consumption of a utility and result in higher costs associated with consuming this utility. In another example, the operational expenditure costs may be based on weather conditions. When the environmental temperature at a geographic location of the retailer is high (e.g., summertime), the energy consuming devices may run at a higher configuration. When combining the increased number of customers with the higher temperatures, the energy consuming devices may run at an even higher configuration. In a further example, the operational expenditure costs may be based on a utility rate (e.g., cost of electricity per unit consumed). The utility rate may be a static value or may be dynamic (e.g., based on time of day). Thus, the energy consuming devices running at a higher configuration may lead to higher operational expenditure costs as increased consumption of a utility at a corresponding utility rate results in increased costs.

When a sale event is scheduled in sync with a time of high energy consumption or other utility, the revenue gains from the higher sales during the sale event may be negated or offset due to the high operational expenditure costs. For example, in a tropical country with higher environmental temperatures, if the sale event is scheduled in afternoon hours in a summer season, the energy costs may increase significantly to cool an interior of the retail space, especially with higher customer numbers inside the retail space of the retailer. In another example, in a cold country with colder environmental temperatures, if the sale event is scheduled in morning or evening hours in a winter season, the energy costs may increase significantly to warm an interior of the retail space. The higher operational expenditure costs in these scenarios may offset the revenue gains from increased sales that result from launching the sale event at this time and day.

With reference again to the illustrative example, the parameters may have indicated that the sale event to be scheduled is during a winter month (e.g., January) in a geographic region having relatively cold days during the winter. The retailer profile 122 may have indicated the utility rates and historical utility consumption at previous times corresponding to the timing parameter included in the request (e.g., increased heating costs from cold air entering the retail space when customers enter and leave). The utility rates may also show a trend indicative of an estimated utility rate at the timeframe specified in the timing parameter. The historical information in the retailer profile 122 may also describe general weather conditions experienced by the retailer at the previous times corresponding to the timing parameter. Further available weather sources (e.g., Farmer's Almanac) may also predict the weather conditions at the timeframe specified in the timing parameter. The historical information in the retailer profile 122 may also describe customer traffic during the previous times corresponding to the timing parameter as well as during matching weather conditions and prior sale events. In this manner, the recommendation program 132 may determine the offsetting factors that may contribute to offsetting gross estimated revenue gains at a scheduled sale event to be launched.

The recommendation program 132 may determine a schedule of one or more sale events for the retailer based on the offsetting factors and an estimated amount of revenue gains from launching a sale event at a scheduled time (step 210). The recommendation program 132 may be configured to estimate revenue gains based on the historical information included in the retailer profile 122 of the retailer. For example, prior sale events (e.g., ones that coincide with a recommended scheduled sale event) may provide insight to predict gross estimated revenue gains from launching another sale event. The recommendation program 132 may utilize any mechanism to determine the estimate of the gross revenue gains for a sale event at a future time. Through incorporation of the offsetting factors, the recommendation program 132 may perform a more comprehensive analysis to schedule a sale event at the retailer that optimizes the net revenue gains (e.g., produces a highest net financial position of the retailer).

The recommendation program 132 may determine the one or more days and the timeframe in the one or more days to launch a sale event. According to the exemplary embodiments, the recommendation program 132 may generate recommendations for when to launch a sale event based on lesser energy consumption or reduced operational expenditure costs that offset revenue gains without affecting or minimally affecting the net financial position of the retailer as well as customer flow (e.g., attracting customers to visit the retailer). The recommendation program 132 may consume the available information in the parameters and the retailer profile 122 along with other available sources to recommend the time slot and day to launch the sale event so that the sale event does not lead to high operational expenditure costs that offset the potential revenue gains.

Returning to the previously introduced example, the recommendation program 132 may determine that the colder environmental temperature at the specified timeframe of the request warrant avoidance of certain operating hours. Accordingly, the recommendation program 132 may determine that other operating hours may generate a higher net financial position from the revenue gains being offset by the offsetting factors. In a different scenario, depending on the various offsetting factors, the recommendation program 132 may determine that despite the colder environmental temperature at the specified timeframe of the request, the expected revenue gains offset by the offsetting factors may still optimize the net financial position of the retailer. Through incorporation of the various offsetting factors that may contribute to reduced revenue gains, the recommendation program 132 may optimize the revenue gains for the net financial position of the retailer by recommending that a sale event be launched at a particular time and date that is specific to the retailer.

The recommendation program 132 may generate and transmit the recommendation for a sale event to be launched to the retailer that submitted the request (step 212). Based on the determinations of the schedule, the recommendation may include one or more schedules of sale events that may be launched at the retailer. For example, the one or more schedules may include entries corresponding to a highest net revenue gain, a second highest net revenue gain, a third highest net revenue gain, etc. The recommendation may enumerate the net estimated revenue gains from using the defined schedule. Based on the scheduled time and day of each recommendation and a net estimated revenue gain from launching the sale event, the recommendation program 132 may incorporate the offsetting factors to determine an expected net revenue which is displayed in the recommendation. In response to receiving the recommendations, the retailer may proceed based on a selected one of the recommendations.

In furtherance of the previously introduced example, the recommendation program 132 may generate the recommendation to schedule a sale event. The recommendation may be transmitted from the recommendation program 132 to the sale client 112 associated with the retailer that submitted the request. The recommendation may be formatted in a user interface that is displayed via the sale client 112. The recommendation may be listed where each recommendation may provide respective information. For example, each recommendation may indicate a recommended time and a recommended day to launch the sale event, an expected revenue from the sale event, the operational expenditure costs to launch the sale event (e.g., as a percentage of revenue), a net expected revenue gain, an expected number of customers, etc.

In an exemplary scenario that may result from the illustrative example described above, the recommendation program 132 may generate a recommendation that lists the top three recommended sale events having the highest net expected revenue gains that may be ordered from highest to lowest. In the exemplary scenario, the utility rate for energy may be higher at early evening hours relative to morning hours or late afternoon hours. There may also be a timing parameter introduced where the sale event is to be launched on Jan. 20, 2019. For example, in a first recommendation, the recommendation program 132 may have determined that a sale event to be launched between the hours of 04:00 PM and 06:00 PM on Jan. 20, 2019 may expect about 20,000 customers and result in an expected revenue of $25,000 with a 10% operational expenditure cost leading to a net expected revenue of $22,500. In another example, in a second recommendation, the recommendation program 132 may have determined that a sale event to be launched between the hours of 06:00 PM and 08:00 PM on January 20^{th}, 2019 may expect about 25,000 customers and result in an expected revenue of $30,000 with a 30% operational expenditure cost leading to a net expected revenue of $21,000. In a further example, in a third recommendation, the recommendation program 132 may have determined that a sale event to be launched between the hours of 10:00 AM and 12:00 PM on Jan. 20, 2019 may expect about 18,000 customers and result in an expected revenue of $20,000 with a 12% operational expenditure cost leading to a net expected revenue of $17,600. Under a conventional approach that does not consider offsetting factors, the second recommendation may appear to be the best option. However, the introduction of the operational expenditure costs that is higher at the indicated time slot actually makes the second recommendation the second best option. For example, the increased customer traffic may entail increased operational expenditure costs (e.g., increased heating bill) that have a higher utility rate. The first recommendation may have a reduced amount of expected customers and reduced amount of retail items being sold. However, the reduced operational expenditure costs may still have a net expected revenue that is greatest.

The exemplary embodiments are configured to recommend when a retailer is to launch a sale event to optimize revenue gains in a net financial position. The exemplary embodiments estimate an expected revenue gain from launching the sale event but also incorporates offsetting factors that may generate a net expected revenue gain that is lower from compensating for operational expenditure costs. Through a comprehensive analysis that considers more than simply selling retail items, the exemplary embodiments may determine a recommendation of when to launch a sale event that produces a highest net expected revenue gain.

FIG. 3 depicts a block diagram of devices within the sale scheduling recommendation system 100 of FIG. 1, in accordance with the exemplary embodiments. It should be appreciated that FIG. 3 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

Based on the foregoing, a computer system, method, and computer program product have been disclosed. However, numerous modifications and substitutions can be made without deviating from the scope of the exemplary embodiments. Therefore, the exemplary embodiments have been disclosed by way of example and not limitation.

It is to be understood that although this disclosure includes a detailed description on cloud computing, implementation of the teachings recited herein are not limited to a cloud computing environment. Rather, the exemplary embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 40 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and the exemplary embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and recommendation processing 96.

The exemplary embodiments may be a system, a method, and/or a computer program product at any possible technical detail level of integration. The computer program product may include a computer readable storage medium (or media) having computer readable program instructions thereon for causing a processor to carry out aspects of the exemplary embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the exemplary embodiments may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the exemplary embodiments.

Aspects of the exemplary embodiments are described herein with reference to flowchart illustrations and/or block diagrams of methods, apparatus (systems), and computer program products according to the exemplary embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various exemplary embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for determining a schedule of a sale event for a retailer, the method comprising:
determining a respective gross revenue gain from launching the sale event at a plurality of times;
for each time,
determining respective offsetting factors that introduce a respective cost that reduces the respective gross revenue gain; and
determining a respective net revenue gain based on the respective gross revenue gain and the respective cost associated with the respective offsetting factors; and
generating a recommendation of a select one of the times having a highest one of the net revenue gains.

2. The computer-implemented method of claim 1, further comprising:
receiving a request from the retailer, the request comprising a parameter defining criteria to be incorporated when generating the recommendation.

3. The computer-implemented method of claim 1, wherein the offsetting factors comprise operational expenditure costs associated with operating the retailer.

4. The computer-implemented method of claim 3, wherein the operational expenditure costs include a utility cost.

5. The computer-implemented method of claim 3, wherein the operational expenditure costs are based on historical operational expenditure costs of the retailer.

6. The computer-implemented method of claim 1, further comprising:
determining a respective expected number of customers at each time of the sale event, the respective offsetting factors being based on the respective expected number of customers.

7. The computer-implemented method of claim 1, wherein the recommendation comprises at least one further one of the times, the at least one further one of the times having a next highest one of the net revenue gains.

8. A computer program product for determining a schedule of a sale event for a retailer, the computer program product comprising:
one or more non-transitory computer-readable storage media and program instructions stored on the one or more non-transitory computer-readable storage media capable of performing a method, the method comprising:
determining a respective gross revenue gain from launching the sale event at a plurality of times;
for each time,
determining respective offsetting factors that introduce a respective cost that reduces the respective gross revenue gain; and
determining a respective net revenue gain based on the respective gross revenue gain and the respective cost associated with the respective offsetting factors; and
generating a recommendation of a select one of the times having a highest one of the net revenue gains.

9. The computer program product of claim 8, wherein the method further comprises:
receiving a request from the retailer, the request comprising a parameter defining criteria to be incorporated when generating the recommendation.

10. The computer program product of claim 8, wherein the offsetting factors comprise operational expenditure costs associated with operating the retailer.

11. The computer program product of claim 10, wherein the operational expenditure costs include a utility cost.

12. The computer program product of claim 10, wherein the operational expenditure costs are based on historical operational expenditure costs of the retailer.

13. The computer program product of claim 8, wherein the method further comprises:
determining a respective expected number of customers at each time of the sale event, the respective offsetting factors being based on the respective expected number of customers.

14. The computer program product of claim 8, wherein the recommendation comprises at least one further one of the times, the at least one further one of the times having a next highest one of the net revenue gains.

15. A computer system for determining a schedule of a sale event for a retailer, the computer system comprising:
one or more computer processors, one or more computer-readable storage media, and program instructions stored on the one or more of the computer-readable storage media for execution by at least one of the one or more processors capable of performing a method, the method comprising:
determining a respective gross revenue gain from launching the sale event at a plurality of times;
for each time,
determining respective offsetting factors that introduce a respective cost that reduces the respective gross revenue gain; and
determining a respective net revenue gain based on the respective gross revenue gain and the respective cost associated with the respective offsetting factors; and
generating a recommendation of a select one of the times having a highest one of the net revenue gains.

16. The computer system of claim 15, wherein the method further comprises:
receiving a request from the retailer, the request comprising a parameter defining criteria to be incorporated when generating the recommendation.

17. The computer system of claim 15, wherein the offsetting factors comprise operational expenditure costs associated with operating the retailer.

18. The computer system of claim 17, wherein the operational expenditure costs include a utility cost.

19. The computer system of claim 17, wherein the operational expenditure costs are based on historical operational expenditure costs of the retailer.

20. The computer system of claim 15, wherein the method further comprises:
determining a respective expected number of customers at each time of the sale event, the respective offsetting factors being based on the respective expected number of customers.
